(19) United States
(12) Patent Application Publication
(10) Pub. No.: US 2006/0089051 A1
(43) Pub. Date: Apr. 27, 2006

(54) FOOLPROOF DEVICE MOUNTING ARRANGEMENT OF A CARD CONNECTOR

(75) Inventor: Sheng-Ching Ko, TAIPEI (TW)

Correspondence Address: JESS-LINK PRODUCTS CO., LTD., P. O. BOX 108-00403, TAIPEI, TW

(73) Assignee: JESS-LINK PRODUCTS CO., LTD., CHUNG HO CITY, TAIPEI HSIEN. (TW)

(21) Appl. No.: 10/904,045

(22) Filed: Oct. 21, 2004

(51) Int. Cl. H01R 24/00

(52) U.S. Cl. 439/630

(57) ABSTRACT

A foolproof device mounting arrangement of a card connector is disclosed to include a metal baffle set in between a first receiving chamber and a second receiving chamber in a connector body and movable vertically between the first receiving chamber and the second receiving chamber to prevent insertion of a second memory card into the connector body after insertion of a first memory card, and a plurality of springy support members mounted inside the connector body for supporting the metal baffle in between the first receiving chamber and the second receiving chamber.

### BACKGROUND OF THE INVENTION

1. Field of the Invention

The present invention relates to a card connector and more particularly, to a foolproof device mounting arrangement of a card connector, which greatly reduces the height of the connector body, and prevents insertion of a second memory card into the connector body after insertion of a first memory card.

2. Description of the Related Art

For the advantages of low power consumption, nonvolatile and shock proofing features and high storage density, flash memories have been intensively used in mobile electronic apparatus to substitute for EEPROM or battery-operated data storage devices. Following fast development of semiconductor technology, the storage density and data transmitting speed of flash memories have been greatly improved. In many devices, a flash memory is used instead of a conventional hard diskdrive. Nowadays, various memory cards have been developed based on flash memory for use in a variety of mobile electronic devices. These memory cards include CF (CompactFlash Card), MMC (MultiMedia Card), SMC (SmartMedia Card), MS (Memory Stick), SD (SecureDigital Memory Card), and XD memory card.

Following fast development of high technology, electronic devices are designed to meet the requirements of modern electronic features such as light, thin, short and small. A mobile electronic device may be provided with a versatile card connector for receiving different types of memory cards. A versatile card connector of this kind has multiple insertion holes for receiving different types of memory cards. Different types of memory cards may be inserted into the insertion holes in different directions. When inserted one memory card into one insertion hole in the wrong direction, the inserted memory card may damage the inside terminals of the card connector, or may be stuck in the card connector. Further, a conventional versatile card connector has no means to prevent insertion of a second memory card after insertion of a first memory card. When two memory cards are in presence in a card connector, the card connector will be unable to make the correct identification judgment, thereby causing failure of the mobile electronic device or loss of storage data. Regular memory cards have different widths and depths. Normally, a versatile card connector provides a relatively greater first insertion hole for receiving PCMCIA/CF (CompactFlash Card), and a relatively smaller second insertion hole formed in the first insertion hole for receiving MMC (MultiMedia Card)/SMC (SmartMedia Card)/MS (Memory Stick)/SD (SecureDigital Memory Card)/XD memory card.

FIG. 7 shows a card connector according to this design, the card connector comprises a connector body A, which defines therein a first receiving chamber A1 and a second receiving chamber A2, and a swivel member B which has a middle part pivotally mounted in between the first receiving chamber A1 and the second receiving chamber A2 with a pivot B1 and two extension portions B2. When inserting one memory card into one receiving chamber A1 (or A2), the memory card will touch one extension portion B2 of the swivel member B to force the swivel member B to turn about the pivot B1 in one direction and to further force the other extension portion B2 of the swivel member B into the other receiving chamber A2 (or A1), preventing insertion of a second memory card into the other receiving chamber A2 (or A1). However, this design of card connector still has drawbacks as outlined hereinafter.

1. Because the swivel member B is pivotally mounted in between the first receiving chamber A1 and the second receiving chamber A2 to prevent insertion of a second memory card after insertion of a first memory card, the first receiving chamber A1 and the second receiving chamber A2 must be kept at different elevations and vertically spaced from each other at a distance. Thus, the thickness of the card connector cannot be effectively reduced to meet the requirements of modern electronic features including light, thin, short and small.

2. The card connector has no foolproof means to prevent insertion of a small size memory card into the insertion hole for big size memory card accidentally.

3. When the user inserts a second memory card into the second receiving chamber (or first receiving chamber) after insertion of a first memory card into the first receiving chamber (or second receiving chamber) due to a mistake, the second memory card will bias the swivel member B to force the other extension portion B2 of the swivel member B against the inserted first memory card, causing the first memory card to displace and to disconnect the connection or data transmission.

Therefore, it is desirable to provide a card connector that eliminates the aforesaid drawbacks.

### SUMMARY OF THE INVENTION

The present invention has been accomplished under the circumstances in view. According to one aspect of the present invention, a foolproof device is provided to prevent insertion of a second memory card into the connector body after insertion of a first memory card. The foolproof device comprises a metal baffle and a plurality of springy support members. The springy support members support the metal baffle in between the first receiving chamber and second receiving chamber of the connector body of the card connector for holding down the inserted memory card in position. This design allows the first receiving chamber and the second receiving chamber to be arranged close to each other to minimize the height of the connector body. According to another aspect of the present invention, the metal baffle of the foolproof device is movable between the first receiving chamber and the second receiving chamber to prevent insertion of a second memory card into the connector body accidentally after insertion of a first memory card into the connector body. According to still another aspect of the present invention, the baffle is made of metal and works as shielding means to shield the inserted memory card against electromagnetic interference. Further, after insertion of a memory card into the connector body, the baffle imparts a pressure to the inserted memory card, thereby holding down the inserted memory card in close contact with the set of terminals of the connector body. According to still another aspect of the present invention, each springy support member of the foolproof device is comprised of a springy base having a top bearing portion and a bottom mounting portion, and a spring supported between the top bearing portion and bottom mounting portion of the springy base. According to still another aspect of the present invention, a terminal adapter is used to hold a part of the set of terminals above the rear part of the circuit board so that different memory cards can be selectively inserted into the first receiving chamber and the second receiving chamber in the same direction, keeping the contacts of the inserted memory card in close contact with the set of terminals.

### BRIEF DESCRIPTION OF THE DRAWINGS

FIG. 1 is an exploded view of a card connector according to the present invention.

FIG. 2 is an elevational assembly view in an enlarged scale of the card connector shown in FIG. 1.

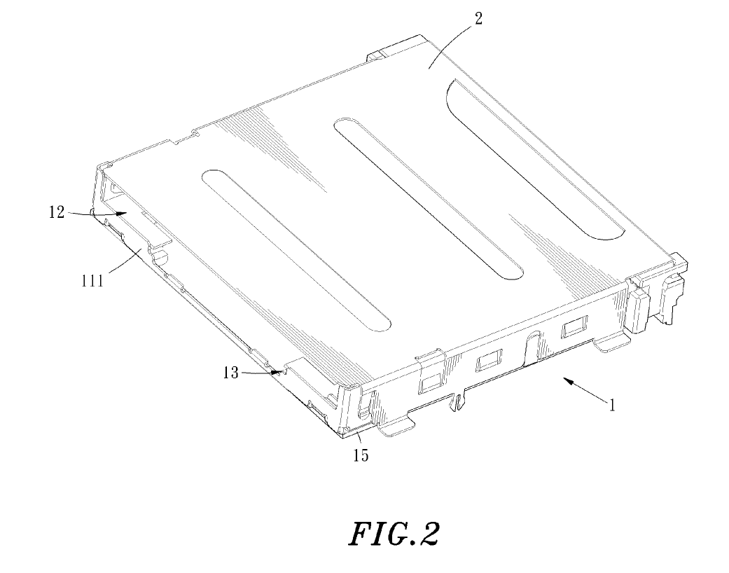

FIG. 3 is a schematic sectional view of a part of the present invention before insertion of a memory card into the connector body.

FIG. 4 is a schematic sectional view of a part of the present invention, showing a memory card inserted into the second receiving chamber.

FIG. 5 is a schematic sectional view of a part of the present invention, showing a memory card inserted into the first receiving chamber (I).

FIG. 6 is a schematic sectional view of a part of the present invention, showing a memory card inserted into the first receiving chamber (II).

FIG. 7 is a side view in section of a card connector according to the prior art.

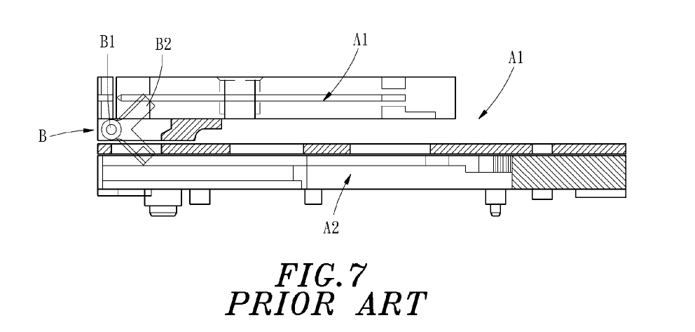

### DETAILED DESCRIPTION OF THE EMBODIMENT

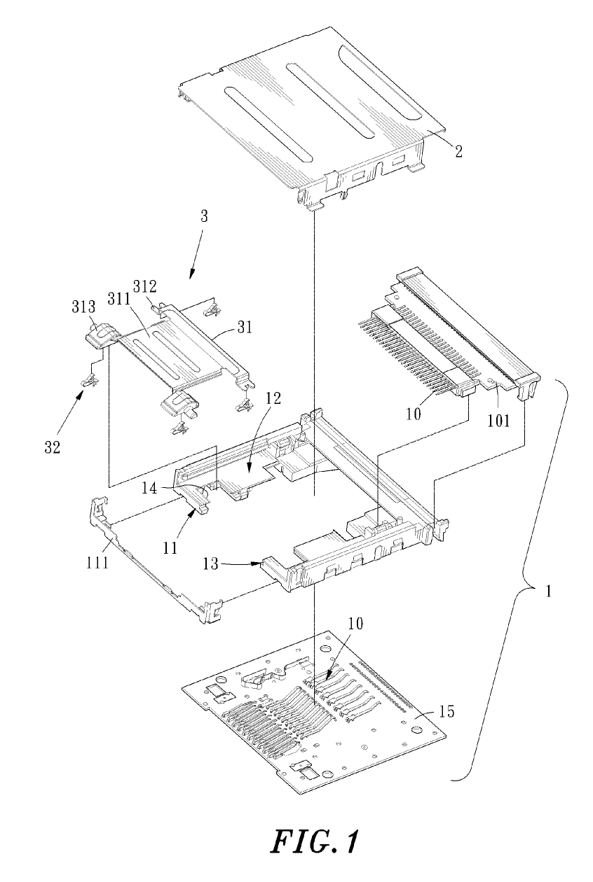

Referring to FIGS. 1—3, a card connector in accordance with the present invention is shown comprised of a connector body 1, a shield 2, and a foolproof device 3.

The connector body 1 comprises a set of terminals 10 for the contact of one of a memory card 4 electrically, an insertion open side 11, a stop plate 111 at the insertion open side 11, a first receiving chamber 12 and a second receiving chamber 13 arranged at different elevations on the inside in communication with the insertion open side 11 for receiving a different memory card 4, a plurality of locating holes 14 symmetrically disposed in communication with the receiving chambers 12 and 13 at two sides, a circuit board 15 mounted on the bottom side beneath the receiving chambers 12 and 13, and a terminal adapter 101 provided above the rear part of the circuit board 15 and holding a part of the set of terminals 10.

The shield 2 is a metal cover plate covered on the connector body 1 to protect the set of terminals 10 and the circuit board 15 against electromagnetic interference.

The foolproof device 3 comprises a metal baffle 31 and a plurality of springy support members 32. The metal baffle 31 has a top bearing surface 311, and a plurality of wings 312 symmetrically disposed at distal ends of the front and rear sides. The two wings 312 that are disposed at the two distal ends of the front side of the metal baffle 31 each have a guide face 313. The springy support members 32 each are comprised of a springy base 321 and a spring 324. The springy base 321 has a top bearing portion 322 and a bottom mounting portion 323. The spring 324 is supported between the top bearing portion 322 and the bottom mounting portion 323.

During assembly process, the bottom mounting portion 323 of the springy base 321 of each of the springy support members 32 is respectively fastened to the circuit board 15, and then the circuit board 15 is fastened to the bottom wall of the connector body 1, and then the metal baffle 3 is mounted in the first receiving chamber 12 to force the wings 312 into the locating holes 14 of the connector body 1 and to keep each wing 312 respectively supported on the top bearing portion 322 of the springy base 321 of one of the springy support members 32, and then the stop plate 111 is fastened to the insertion open side 11 of the connector body 1, and then the shield 2 is covered on the top side of the connector body 1.

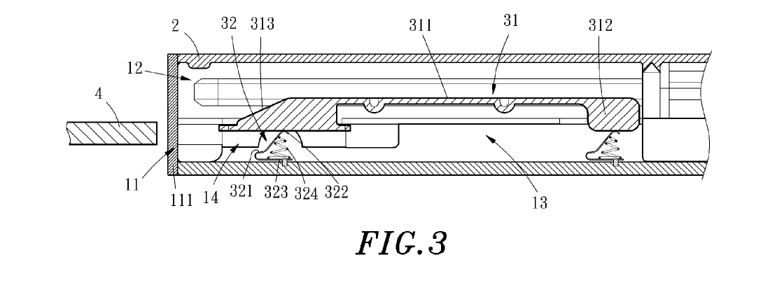

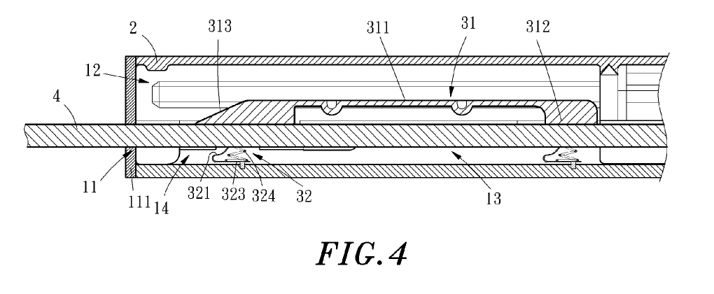

Referring to FIG. 4 and FIG. 3 again, when inserted one memory card (first type memory card of relatively smaller size) 4 through the insertion open side 11 into the second receiving chamber 13, the baffle 31 of the foolproof device 3 is stopped at the top side of the inserted memory card 4 and kept in the first receiving chamber 12 to prevent insertion of a memory card into the first receiving chamber 12.

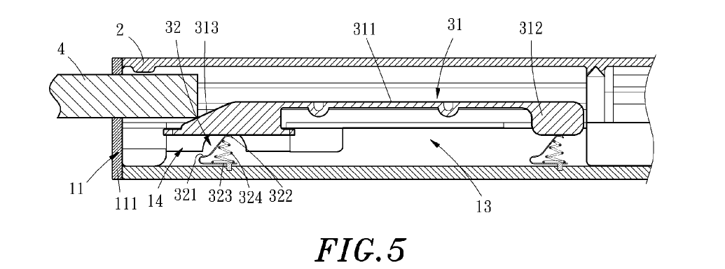

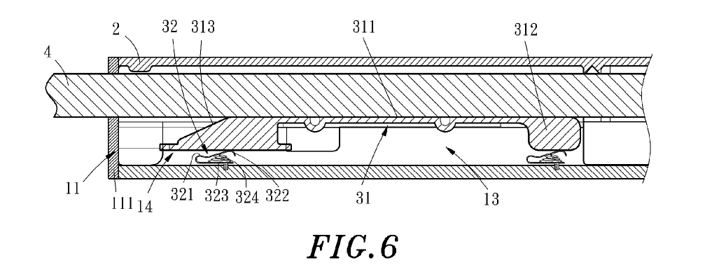

Referring to FIGS. 5 and 6 and FIG. 3 again, when inserting one memory card (second type memory card of relatively greater size) 4 through the insertion open side 11 into the first receiving chamber 12, the memory card 4 will be moved over the guide face 313 of each of the two wings 312 at the two distal ends of the front side of the metal baffle 31 to lower the metal baffle 31 of the foolproof device 3 from the first receiving chamber 12 to the second receiving chamber 13, thereby causing the metal baffle 31 to compress the springy support members 32. At this time, the top bearing surface 311 is forced upward by the spring force of the springs 324 of the springy support members 32 and pressed on the bottom side of the inserted memory card 4 to hold the inserted memory card 4 in positive contact with the set of terminals 10 (see also FIG. 1), and the metal baffle 31 is held in the second receiving chamber 13 to prohibit insertion of a memory card into the second receiving chamber 13. After removal of the inserted memory card 4 from the first receiving chamber 12, the springy support members 32 return to their former shape to lift the metal baffle 31 upwards from the second receiving chamber 13 to the first receiving chamber 12.

Further, the stop plate 111 has a profile fitting the front side of the first receiving chamber 12 and the front side of the second receiving chamber 13 for guiding insertion of a memory card into the first receiving chamber 12 or second receiving chamber 13. When inserting a wrong type memory card into the first receiving chamber 12 accidentally, the inserted memory card will be stopped against the front side of the metal baffle 31 without touching the guide face 313 of each of the two wings 312 at the two distal ends of the front side of the metal baffle 31, thereby preventing a mistake.

Further, when inserting a memory card 4 into the connector body 1, the user must pay attention to the insertion direction so that the contacts of the inserted memory card 4 can be kept in close contact with the set of terminals 10 electrically. The invention uses the terminal adapter 101 to hold a part of the set of terminals 10 above the rear part of the circuit board 15 so that different memory cards can be selectively inserted into the first receiving chamber 12 and the second receiving chamber 13 in the same direction, keeping the contacts of the inserted memory card 4 in close contact with the set of terminals 10. Therefore, the invention prevents insertion of a memory card into the first receiving chamber 12 or second receiving chamber 13 in the wrong direction. Inserting a memory card 4 into the connector body 1 in the wrong direction may damage the structure of the set of terminals 10, or cause sticking of the inserted memory card 4 in the connector body 1.

Further, because the baffle 31 is made of metal, the baffle 31 shields the inserted memory card 4 against electromagnetic interference. After insertion of a memory card 4 into the connector body 1, the baffle 31 imparts a pressure to the inserted memory card 4, thereby holding down the inserted memory card 4 in close contact with the set of terminals 10.

As indicated above, the foolproof device 3 is set in between the first receiving chamber 12 and the second receiving chamber 13, and the springy support members 32 of the foolproof device 3 support the metal baffle 31 in position for protection. The first receiving chamber 12 and the second receiving chamber 13 are different in size to receive different types memory cards 4 that have different sizes. Because the metal baffle 31 is supported on the springy support members 32, the metal baffle 31 is movable vertically between the first receiving chamber 12 and the second receiving chamber 13 to prohibit insertion of a second memory card into the connector body 1 accidentally after insertion of one memory card into the first receiving chamber 12 or second receiving chamber 13. Further, by means of the use of the terminal adapter 101, the insertion direction of a memory card into the first receiving chamber 12 is same as the insertion direction of a memory card into the second receiving chamber 13. Further, the first receiving chamber 12 and the second receiving chamber 13 are respectively designed for receiving different memory cards. Each receiving chamber 12 or 13 can be designed to receive one specific type or two different types of memory cards. The card connector of the invention can be designed to receive any of a variety of memory cards 4 including CF (CompactFlash Card), MMC (MultiMedia Card), SMC (SmartMedia Card), MS (Memory Stick), SD (SecureDigital Memory Card), and XD memory card.

As indicated above, the foolproof device mounting arrangement of a card connector according to the present invention has the following features.

1. The springy support members 32 of the foolproof device 3 support the metal baffle 31 in between the first receiving chamber 12 and the second receiving chamber 13 for holding down the inserted memory card 4. This design allows the first receiving chamber 12 and the second receiving chamber 13 to be arranged close to each other to minimize the height of the connector body 1.

2. The metal baffle 31 of the foolproof device 3 is movable between the first receiving chamber 12 and the second receiving chamber 13 to prevent insertion of a second memory card into the connector body 1 accidentally after insertion of a fist memory card into the connector body 1.

3. The baffle 31 is made of metal and works as shielding means to shield the inserted memory card 4 against electromagnetic interference. Further, after insertion of a memory card 4 into the connector body 1, the baffle 31 imparts a pressure to the inserted memory card 4, thereby holding down the inserted memory card 4 in close contact with the set of terminals 10.

4. Each springy support member 32 of the foolproof device 3 is comprised of the springy base 321 having the top bearing portion 322 and the bottom mounting portion 323, and the spring 324 supported between the top bearing portion 322 and bottom mounting portion 323 of the springy base 321. Because each springy support member 32 is comprised of the springy base 321 and the spring 324, the foolproof device 3 prevents occurrence of elastic fatigue in a short period.

5. The invention uses the terminal adapter 101 to hold a part of the set of terminals 10 above the rear part of the circuit board 15 so that different memory cards can be selectively inserted into the first receiving chamber 12 and the second receiving chamber 13 in the same direction, keeping the contacts of the inserted memory card 4 in close contact with the set of terminals 10.

A prototype of foolproof device for card connector has been constructed with the features of FIGS. 1—6. The foolproof device for card connector functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A foolproof device mounting arrangement comprising:
a connector body, said connector body having a first receiving chamber and a second receiving chamber arranged at different elevations, a front insertion open side through which a memory card is insertable into one of said first receiving chamber and said second receiving chamber, and a set of terminals installed in said first receiving chamber and said second receiving chamber for the contact of the contacts of the memory card; and
a foolproof device adapted to prevent insertion of a second memory card into said connector body after insertion of a first memory card into one of said first receiving chamber and said second receiving chamber, said foolproof device comprising a baffle set in between said first receiving chamber and said second receiving chamber and movable vertically between said first receiving chamber and said second receiving chamber, said baffle having a top bearing surface for bearing the inserted memory card, and a plurality of springy support members mounted inside said connector body and adapted to support said baffle in between said first receiving chamber and said second receiving chamber.

2. The foolproof device mounting arrangement as claimed in claim 1, wherein said baffle has a plurality of wings symmetrically disposed at two opposite lateral sides thereof and respectively supported on said springy support members; said connector body comprises a plurality of locating holes symmetrically disposed in communication with said first receiving chamber and said second receiving chamber at two sides for accommodating said wings.

3. The foolproof device mounting arrangement as claimed in claim 1, wherein said baffle has at least one front guide face for guiding the inserted memory card into contact with said top bearing surface.

4. The foolproof device mounting arrangement as claimed in claim 1, wherein each said springy support member comprises a springy base, said spring base having a top bearing portion adapted to support said baffle and a bottom mounting portion fastened to the inside of said connector body, and a spring supported between the top bearing portion and bottom mounting portion of said spring base.

5. The foolproof device mounting arrangement as claimed in claim 1, wherein said baffle is made of a metal material.

6. The foolproof device mounting arrangement as claimed in claim 1, further comprising a metal shield covered on a top side of said connector body.

7. The foolproof device mounting arrangement as claimed in claim 1, wherein said connector body comprises a stop plate mounted in said front insertion open side for guiding one of different memory cards into one of said first receiving chamber and said second receiving chamber.

8. The foolproof device mounting arrangement as claimed in claim 1, wherein said connector body further comprises a circuit board mounted in a bottom side thereof and holding a part of said set of terminals.

9. The foolproof device mounting arrangement as claimed in claim 8, wherein said connector body further comprises a terminal adapter provide above a rear part of said circuit board and holding a part of said set of terminals.
